(19) United States
(12) Patent Application Publication
(10) Pub. No.: US 2026/0245802 A1
(43) Pub. Date: Aug. 20, 2026

(54) MULTILAYER CERAMIC CAPACITOR

(71) Applicant: Murata Manufacturing Co., Ltd., Nagaokakyo-shi (JP)

(72) Inventor: Yukie WATANABE, Nagaokakyo-shi (JP)

(21) Appl. No.: 19/642,862

(22) Filed: Apr. 9, 2026

Related U.S. Application Data
(63) Continuation of application No. PCT/JP2024/044428, filed on Dec. 16, 2024.

(30) Foreign Application Priority Data
Feb. 13, 2024 (JP) 2024-019174

(51) Int. Cl. H01G 4/252; H01G 4/30

(52) U.S. Cl. CPC H01G 4/252; H01G 4/30

(57) ABSTRACT

A multilayer ceramic capacitor includes a multilayer body including dielectric layers and inner electrode layers stacked in a stacking direction, and first and second outer electrodes each including a plating layer including a cushion portion protruding from a first principal surface of the multilayer body and a joint portion protruding from a second principal surface of the multilayer body. A maximum distance in the laminating direction by which the cushion portion protrudes from the first principal surface of the multilayer body is longer than a maximum distance in the laminating direction by which the joint portion protrudes from the second principal surface of the multilayer body.

### CROSS REFERENCE TO RELATED APPLICATIONS

This application claims the benefit of priority to Japanese Patent Application No. 2024-019174 filed on Feb. 13, 2024 and is a Continuation Application of PCT Application No. PCT/JP2024/044428 filed on Dec. 16, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In recent years, electronic devices such as mobile phones or portable music players have become smaller and thinner. This further contributes to a reduction in both size and thickness of multilayer ceramic electronic components mounted in the smaller and thinner electronic devices.

As described in Japanese Unexamined Patent Application Publication No. 2014-183186, for example, such multilayer ceramic capacitors, which are multilayer ceramic electronic components, include dielectric chips in which dielectric ceramics, such as barium titanate, and inner electrodes are alternately laminated, and outer electrodes configured to cover respective lengthwise end portions of the dielectric chips (See Japanese Unexamined Patent Application Publication No. 2014-183186). The multilayer ceramic capacitor disclosed in Japanese Unexamined Patent Application Publication No. 2014-183186 is a low-profile multilayer ceramic capacitor having a dimension in a height direction of, for example, 150 μm or less. When mounted on a substrate, such a multilayer ceramic capacitor is mounted thereon using a mounter.

### SUMMARY OF THE INVENTION

In a low-profile multilayer ceramic capacitor, however, cracks might occur in or on a multilayer body of the multilayer ceramic capacitor, due to impact caused by a nozzle of a mounter during mounting, resulting in poor insulation.

Therefore, example embodiments of the present invention provide multilayer ceramic capacitors that each reduce or prevent concentration of stress on a multilayer body during mounting and prevent cracks from occurring in or on the multilayer body.

A multilayer ceramic capacitor according to an example embodiment of the present invention includes a multilayer body including a plurality of dielectric layers and a plurality of inner electrode layers that are laminated, a first principal surface and a second principal surface that face each other in a laminating direction, a first side surface and a second side surface that face each other in a width direction orthogonal to the laminating direction, and a first end surface and a second end surface that face each other in a length direction orthogonal to the laminating direction and the width direction, a first outer electrode coupled to one of the inner electrode layers and located on the first end surface and the second principal surface, and a second outer electrode coupled to one of the inner electrode layers and located on the second end surface and the second principal surface, the second principal surface of the multilayer body is a mounting surface, the first outer electrode includes a first principal surface electrode on the first end surface and the second principal surface, and a first plating layer covering the first principal surface electrode and located on the first end surface and the second principal surface, the second outer electrode includes a second principal surface electrode on the second end surface and the second principal surface, and a second plating layer covering the second principal surface electrode and located on the second end surface and the second principal surface, the first plating layer and the second plating layer each include a cushion portion protruding from the first principal surface of the multilayer body and a joint portion protruding from the second principal surface of the multilayer body, and a maximum distance in the laminating direction by which the cushion portion protrudes from the first principal surface of the multilayer body is longer than a maximum distance in the laminating direction by which the joint portion protrudes from the second principal surface of the multilayer body.

According to a multilayer ceramic capacitor according to an example embodiment of the present invention, the first plating layer and the second plating layer each include the cushion portion protruding from the first principal surface of the multilayer body and the joint portion protruding from the second principal surface of the multilayer body, and the maximum distance in the laminating direction by which the cushion portion protrudes from the first principal surface of the multilayer body is longer than the maximum distance in the laminating direction by which the joint portion protrudes from the second principal surface of the multilayer body, so that a nozzle of a mounter hits the cushion portion which can then absorb stress on the multilayer body like a cushion. This makes it possible to further alleviate stress on the multilayer body.

A multilayer ceramic capacitor according to an example of the present invention includes a multilayer body including a plurality of dielectric layers and a plurality of inner electrode layers that are laminated, a first principal surface and a second principal surface that face each other in a laminating direction, a first side surface and a second side surface that face each other in a width direction orthogonal to the laminating direction, and a third side surface and a fourth side surface that face each other in a length direction orthogonal to the laminating direction and the width direction, a first outer electrode coupled to one of the inner electrode layers and located on the first side surface, the third side surface, and the second principal surface, a second outer electrode coupled to one of the inner electrode layers and located on the second side surface, the fourth side surface, and the second principal surface, a third outer electrode coupled to one of the inner electrode layers and located on the first side surface, the fourth side surface, and the second principal surface, and a fourth outer electrode coupled to one of the inner electrode layers and located on the second side surface, the third side surface, and the second principal surface, the second principal surface of the multilayer body is a mounting surface, the first outer electrode includes a first principal surface electrode located on the first side surface, the third side surface, and the second principal surface, and a first plating layer covering the first principal surface electrode and located on the first side surface, the third side surface, and the second principal surface, the second outer electrode includes a second principal surface electrode located on the second side surface, the fourth side surface, and the second principal surface, and a second plating layer covering the second principal surface electrode and located on the second side surface, the fourth side surface, and the second principal surface, the third outer electrode includes a third principal surface electrode located on the first side surface, the fourth side surface, and the second principal surface, and a third plating layer covering the third principal surface electrode and located on the first side surface, the fourth side surface, and the second principal surface, the fourth outer electrode includes a fourth principal surface electrode located on the second side surface, the third side surface, and the second principal surface, a fourth plating layer covering the fourth principal surface electrode and located on the second side surface, the third side surface, and the second principal surface, and the first plating layer, the second plating layer, the third plating layer, and the fourth plating layer each include a cushion portion protruding from the first principal surface of the multilayer body and a joint portion protruding from the second principal surface of the multilayer body, and a maximum distance in the laminating direction by which the cushion portion protrudes from the first principal surface of the multilayer body is longer than a maximum distance in the laminating direction by which the joint portion protrudes from the second principal surface of the multilayer body.

According to a multilayer ceramic capacitor according to an example embodiment of the present invention, the first plating layer, the second plating layer, the third plating layer, and the fourth plating layer each include the cushion portion protruding from the first principal surface of the multilayer body and the joint portion protruding from the second principal surface of the multilayer body, and the maximum distance in the laminating direction by which the cushion portion protrudes from the first principal surface of the multilayer body is longer than the maximum distance in the laminating direction by which the joint portion protrudes from the second principal surface of the multilayer body, so that a nozzle of a mounter hits the cushion portion which can then absorb stress on the multilayer ceramic capacitor like a cushion. This makes it possible to further alleviate stress on the multilayer ceramic capacitor.

According to example embodiments of the present invention, it is possible to provide multilayer ceramic capacitors that each may reduce or prevent concentration of stress on a multilayer body during mounting and prevent cracks from occurring in or on the multilayer body.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor according to a first example embodiment of the present invention.

FIG. 2 is a front view illustrating the multilayer ceramic capacitor according to the first example embodiment of the present invention.

FIG. 3 is a cross-sectional view taken along line III-III in FIG. 1.

FIG. 4 is a cross-sectional view taken along line IV-IV in FIG. 1.

FIG. 5 is a diagram of the multilayer ceramic capacitor according to the first example embodiment of the present invention when mounted on a mounting substrate.

FIG. 6 is an external perspective view illustrating a multilayer ceramic capacitor according to a second example embodiment of the present invention.

FIG. 7 is a front view of the multilayer ceramic capacitor according to the second example embodiment of the present invention.

FIG. 8 is a cross-sectional view taken along line VIII-VIII in FIG. 6.

FIG. 9 is a cross-sectional view taken along line IX-IX in FIG. 6.

FIG. 10 is an external perspective view illustrating a multilayer ceramic capacitor according to a third example embodiment of the present invention.

FIG. 11 is a cross-sectional view along line XI-XI in FIG. 10.

FIG. 12 is a cross-sectional view along line XII-XII in FIG. 10.

FIG. 13 is a cross-sectional view along line XIII-XIII in FIG. 10.

FIG. 14 is an exploded perspective view of a multilayer body illustrated in FIG. 10.

### DETAILED DESCRIPTION OF THE EXAMPLE EMBODIMENTS

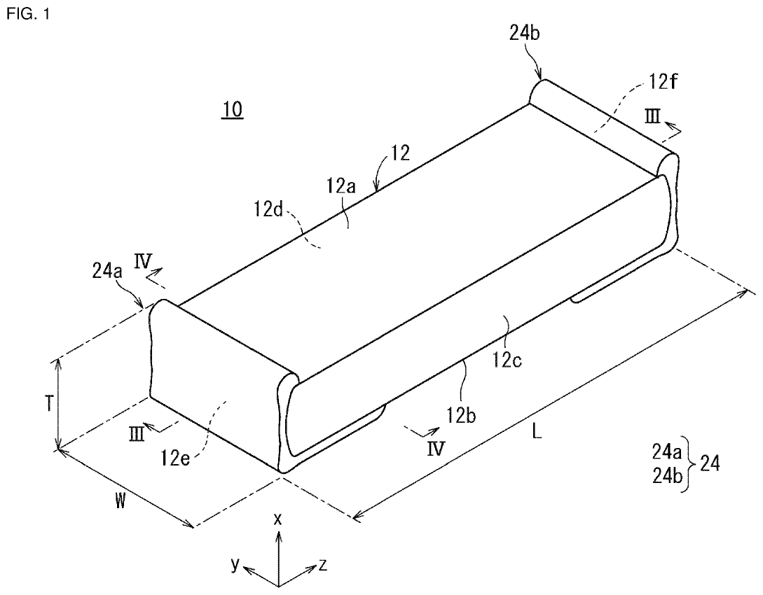

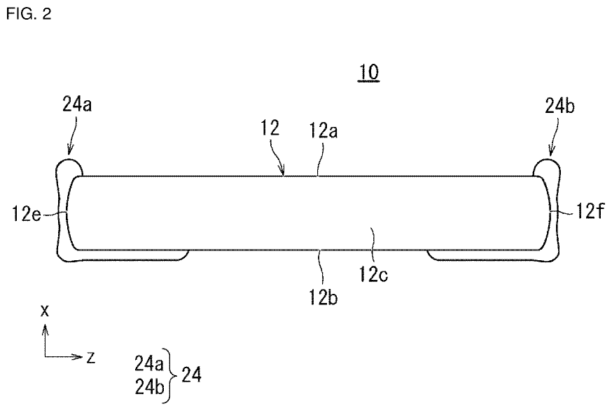

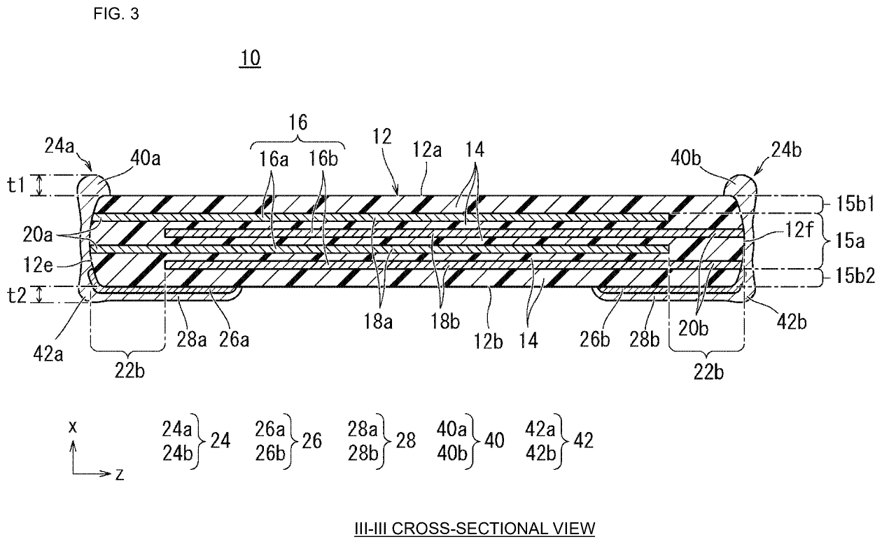

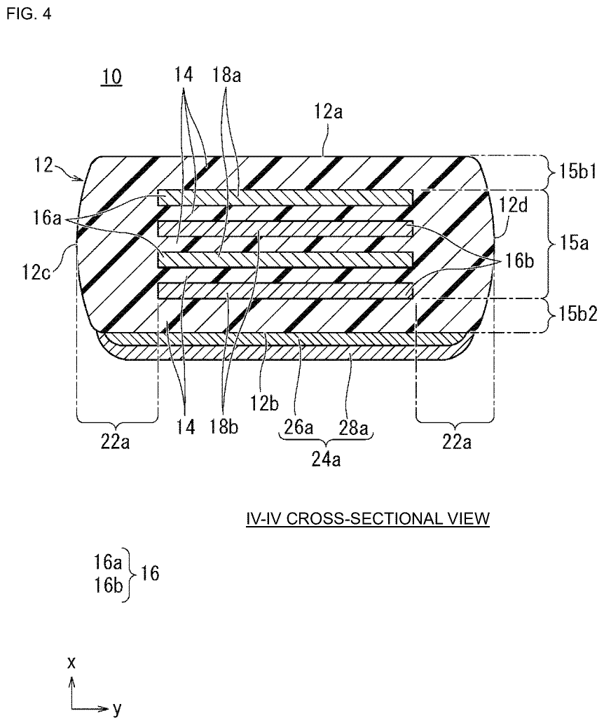

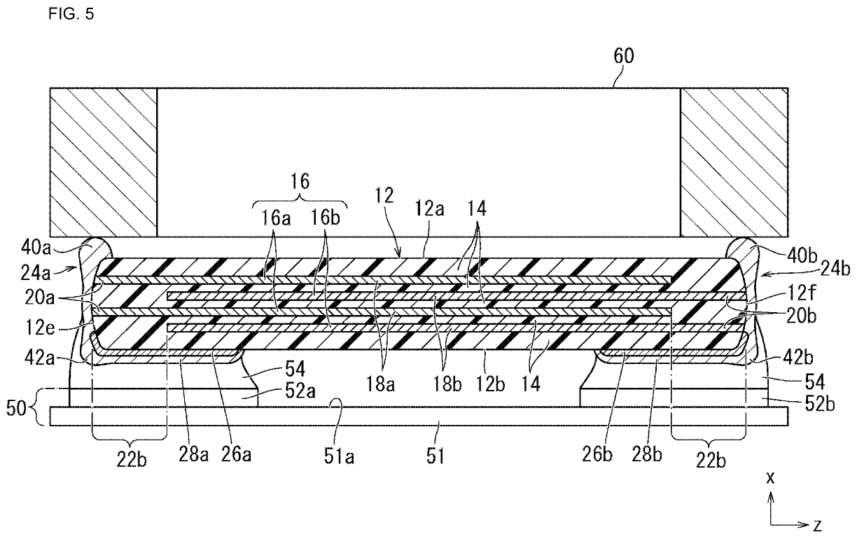

A description will be given of a multilayer ceramic capacitor 10 according to a first example embodiment of the present invention. FIG. 1 is an external perspective view of the multilayer ceramic capacitor according to the first example embodiment of the present invention. FIG. 2 is a front view illustrating the multilayer ceramic capacitor according to the first example embodiment of the present invention. FIG. 3 is a cross-sectional view taken along line III-III in FIG. 1. FIG. 4 is a cross-sectional view taken along line IV-IV in FIG. 1. FIG. 5 is a diagram of the multilayer ceramic capacitor according to the first example embodiment of the present invention when mounted on a mounting substrate.

The multilayer ceramic capacitor 10 includes a multilayer body 12 and an outer electrode 24. In the following, a configuration of each of the multilayer body 12 and the outer electrode 24 will be described in this order.

The multilayer body 12 includes a plurality of dielectric layers 14 and a plurality of inner electrode layers 16 that are laminated. The multilayer body 12 further includes a first principal surface 12a and a second principal surface 12b that face each other in a laminating direction x, a first side surface 12c and a second side surface 12d that face each other in a width direction y orthogonal to the laminating direction x, and a first end surface 12e and a second end surface 12f that face each other in a length direction z orthogonal to the laminating direction x and the width direction y.

The multilayer body 12 includes rounded corner portions and ridge portions. Note that a corner portion refers to a portion where three adjacent surfaces of the multilayer body 12 intersect, and a ridge portion refers to a portion where two adjacent surfaces of the multilayer body 12 intersect. In addition, irregularities or the like may be provided on some or all of the first principal surface 12a and the second principal surface 12b, the first side surface 12c and the second side surface 12d, and the first end surface 12e and the second end surface 12f. The second principal surface 12b side of the multilayer body 12 is a mounting surface.

As illustrated in FIG. 3 and FIG. 4, the multilayer body 12 includes, in the laminating direction x that connects the first principal surface 12a and the second principal surface 12b, an inner layer portion 15a, in which a plurality of inner electrode layers 16 face each other, a first outer layer portion 15b1 including the plurality of dielectric layers 14 located between the inner electrode layers 16 positioned closest to the first principal surface 12a side and the first principal surface 12a, and a second outer layer portion 15b2 including the plurality of dielectric layers 14 located between the inner electrode layers 16 positioned closest to the second principal surface 12b side and the second principal surface 12b.

The first outer layer portion 15b1 is a collection of the plurality of dielectric layers 14 located on the first principal surface 12a side of the multilayer body 12 and located between the first principal surface 12a and the inner electrode layer 16 positioned closest to the first principal surface 12a.

The second outer layer portion 15b2 is a collection of the plurality of dielectric layers 14 located on the second principal surface 12b side of the multilayer body 12 and located between the second principal surface 12b and the inner electrode layer 16 positioned closest to the second principal surface 12b.

Then, a region sandwiched between the first outer layer portion 15b1 and the second outer layer portion 15b2 is the inner layer portion 15a.

The dielectric layers 14 may include, for example, a dielectric material. As a dielectric material, a dielectric ceramic mainly including, for example, BaTiO₃, CaTiO₃, SrTiO₃, CaZrO₃, or the like, can be used. Alternatively, a dielectric material may also be used in which a subcomponent, such as a Mn compound, an Fe compound, a Cr compound, a Co compound, and a Ni compound, is added to these main components.

As illustrated in FIG. 3 and FIG. 4, the inner electrode layers 16 include first inner electrode layers 16a and the second inner electrode layers 16b. The first inner electrode layers 16a and the second inner electrode layers 16b are alternately laminated with the dielectric layers 14 interposed therebetween.

The first inner electrode layer 16a is disposed on a surface of the dielectric layer 14. The first inner electrode layer 16a includes a first opposing electrode portion 18a facing the second inner electrode layer 16b, and a first lead-out electrode portion 20a located on one end side of the first inner electrode layer 16a and extending from the first opposing electrode portion 18a to the first end surface 12e of the multilayer body 12. The first lead-out electrode portion 20a has its end portion drawn out to and exposed at the first end surface 12e.

A shape of the first opposing electrode portion 18a of the first inner electrode layer 16a is not particularly limited but is preferably rectangular in a plan view. Nevertheless, in plan view, the corner portions may be rounded or may be formed obliquely (tapered). Alternatively, the first opposing electrode portion 18a may be tapered in plan view, sloping toward either side.

A shape of the first lead-out electrode portion 20a of the first inner electrode layer 16a is not particularly limited but is preferably rectangular in a plan view. Nevertheless, in plan view, the corner portions may be rounded or may be formed obliquely (tapered). Alternatively, the first lead-out electrode portion 20a may be tapered in plan view, sloping toward either side.

The first opposing electrode portion 18a of the first inner electrode layer 16a and the first lead-out electrode portion 20a of the first inner electrode layer 16a may have the same length in the width direction y. Alternatively, either one of the first opposing electrode portion 18a or the first lead-out electrode portion 20a of the first inner electrode layer 16a may have a shorter length in the width direction y.

The second inner electrode layer 16b is disposed on a surface of the dielectric layer 14 that differs from the dielectric layer 14 on which the first inner electrode layer 16a is disposed. The second inner electrode layer 16b includes a second opposing electrode portion 18b facing the first inner electrode layer 16a, and a second lead-out electrode portion 20b located on one end side of the second inner electrode layer 16b and extending from the second opposing electrode portion 18b to the second end surface 12f of the multilayer body 12. The second lead-out electrode portion 20b has its end portion drawn out to and exposed at the second end surface 12f.

A shape of the second opposing electrode portion 18b of the second inner electrode layer 16b is not particularly limited but is preferably rectangular in a plan view. Nevertheless, in plan view, the corner portions may be rounded or may be formed obliquely (tapered). Alternatively, the second opposing electrode portion 18b may be tapered in plan view, sloping toward either side.

A shape of the second lead-out electrode portion 20b of the second inner electrode layer 16b is not particularly limited but is preferably rectangular in a plan view. Nevertheless, in plan view, the corner portions may be rounded or may be formed obliquely (tapered). Alternatively, the second lead-out electrode portion 20b may be tapered in plan view, sloping toward either side.

The second opposing electrode portion 18b of the second inner electrode layer 16b and the second lead-out electrode portion 20b of the second inner electrode layer 16b may be formed to have the same length in the width direction y. Alternatively, either one of the second opposing electrode portion 18b or the second lead-out electrode portion 20b of the second inner electrode layer 16b may have a shorter length in the width direction y.

The first inner electrode layer 16a and the second inner electrode layer 16b include, for example, Ni as a main component, and at least one of metals such as Cu, Ag, Pd, or Au or an alloy such as an Ag-Pd alloy, or the like. The inner electrode layer 16 may further include dielectric particles of the same composition system as the dielectric material included in the dielectric layer 14.

In addition, Sn may be included in the first inner electrode layer 16a and the second inner electrode layer 16b. By including Sn in the first inner electrode layer 16a and the second inner electrode layer 16b, it is possible to alleviate concentration of electric fields on an interface between the first inner electrode layer 16a and the second inner electrode layer 16b and the dielectric layer 14, which leads to improvement of high temperature load reliability. At this time, Sn can be sufficiently effective even if Sn is included in only one of the first inner electrode layer 16a and the second inner electrode layer 16b.

It is preferable that the inner electrode layer 16, that is, the first inner electrode layer 16a and the second inner electrode layer 16 b, has a thickness of about 0.2 μm or more and about 2.0 μm or less, for example.

In addition, it is preferable that a total number of the first inner electrode layers 16a and the second inner electrode layers 16b be 5 or more and 2000 or less, for example.

Furthermore, as illustrated in FIG. 3, the multilayer body 12 includes end portions (hereinafter referred to as “L gaps”) 22b of the multilayer body 12 that are located between one end portion opposite to the first lead-out electrode portion 20a of the first inner electrode layer 16a and the second end surface 12f, and between an end portion opposite to the second lead-out electrode portion 20b of the second inner electrode layer 16b and the first end surface 12e.

In addition, as illustrated in FIG. 4, the multilayer body 12 includes side portions (hereinafter referred to as “W gaps”) 22a of the multilayer body 12 that are located between one end in the width direction y of the first opposing electrode portion 18a and the second opposing electrode portion 18b and the first side surface 12c, and between another end in the width direction y of the first opposing electrode portion 18a and the second opposing electrode portion 18b and the second side surface 12d.

In this example embodiment, it is preferable that the first end surface 12e of the multilayer body 12 be curved from the first principal surface 12a to the second principal surface 12b. It is also preferable that the second end surface 12f of the multilayer body 12 be curved from the first principal surface 12a to the second principal surface 12b. With such a configuration, at the end surfaces 12e, 12f of the multilayer body 12, the inner electrode layer 16 is not exposed at the middle side of the multilayer body 12 in the laminating direction x, and the inner electrode layer 16 can be exposed from the middle side of the multilayer body 12 in the laminating direction x toward the first principal surface 12a or the second principal surface 12b.

As illustrated in FIG. 1 to FIG. 3, the outer electrode 24 is disposed on each of the first end surface 12e side and the second end surface 12f side of the multilayer body 12.

The outer electrode 24 includes a first outer electrode 24a and a second outer electrode 24b.

The first outer electrode 24a is disposed on the first end surface 12e and the second principal surface 12b of the multilayer body 12. In this case, the first outer electrode 24a is electrically coupled to the first lead-out electrode portion 20a of the first inner electrode layer 16a.

The second outer electrode 24b is disposed on the second end surface 12f and the second principal surface 12b of the multilayer body 12. In this case, the second outer electrode 24b is electrically coupled to the second lead-out electrode portion 20b of the second inner electrode layer 16b.

Within the multilayer body 12, electrostatic capacitance is generated by the first opposing electrode portion 18a of the first inner electrode layer 16a and the second opposing electrode portion 18b of the second inner electrode layer 16b facing each other with the dielectric layer 14 interposed therebetween. As a result, it is possible to obtain electrostatic capacitance between the first outer electrode 24a to which the first inner electrode layer 16a is coupled and the second outer electrode 24b to which the second inner electrode layer 16b is coupled, and capacitor characteristics are exhibited.

The outer electrode 24 includes a principal surface electrode 26 and a plating layer 28 configured to cover the principal surface electrode 26. More specifically, the first outer electrode 24a includes a first principal surface electrode 26a disposed on the first end surface 12e and the second principal surface 12b, and a first plating layer 28a that covers the first principal surface electrode 26a and is disposed on the first end surface 12e and the second principal surface 12b. In addition, the second outer electrode 24b includes a second principal surface electrode 26b disposed on the second end surface 12f and the second principal surface 12b, and a second plating layer 28b that covers the second principal surface electrode 26b and is disposed on the second end surface 12f and the second principal surface 12b.

The principal surface electrode 26 includes the first principal surface electrode 26a and the second principal surface electrode 26b.

The first principal surface electrode 26a extends from the ridge portion to which the first end surface 12e and the second principal surface 12b of the multilayer body 12 are connected, to the first end surface 12e and the second principal surface 12b of the multilayer body 12, and is configured to cover the first end surface 12e and a portion of the second principal surface 12b of the multilayer body 12. The second principal surface electrode 26b extends from the ridge portion to which the second end surface 12f and the second principal surface 12b of the multilayer body 12 are connected, to the second end surface 12f and the second principal surface 12b of the multilayer body 12, and is configured to cover the second end surface 12f and a portion of the second principal surface 12b of the multilayer body 12.

It is preferable that the principal surface electrode 26 be formed by a thin film forming method such as a sputtering method or a vapor deposition method, or the like. In particular, it is preferable that the principal surface electrode 26 be a sputtered electrode formed by the sputtering method.

It is preferable that, as the principal surface electrode 26, a sputtered electrode be directly formed on a portion of the second principal surface 12b of the multilayer body 12, and on a portion of the first end surface 12e or a portion of the second end surface 12f. The principal surface electrode 26 includes at least one of Ni, Cr, Cu, or Ti, or the like.

The principal surface electrode 26 may also include metals, such as Ni, Cu, Ag, Pd, an Ag-Pd alloy, or Au, for example. At this time, it is preferable that the principal surface electrode 26 include, as a co-material, the same dielectric material as the dielectric ceramic included in the dielectric layer 14. By including the co-material, shrink behavior of the principal surface electrode 26 during firing can be made closer to the shrink behavior of the multilayer body 12, which thus makes it possible to prevent peeling of the principal surface electrode 26 from the multilayer body 12.

The plating layer 28 includes the first plating layer 28a and the second plating layer 28b.

The first plating layer 28a covers the first principal surface electrode 26a. The second plating layer 28b covers the second principal surface electrode 26b.

The plating layer 28 includes, for example, at least one of Ni, Sn, Cu, Ag, Pd, an Ag-Pd alloy, or Au, or the like. It is preferable that the plating layer 28 include, for example, at least one of a Cu plating layer, a Ni plating layer, or a Sn plating layer.

The plating layer 28 may include a plurality of layers.

For example, in a case where the plating layer 28 has a two-layer structure, the plating layer 28 includes a Ni plating layer covering the principal surface electrode 26 and a Sn plating layer configured to cover the Ni plating layer.

In addition, for example, in a case where the plating layer 28 has a three-layer structure, the plating layer 28 includes a Cu plating layer covering the principal surface electrode 26, a Ni plating layer configured to cover the Cu plating layer, and a Sn plating layer configured to cover the Ni plating layer.

By being provided so as to cover a surface of the principal surface electrode 26, the Cu plating layer has the effect of reducing or preventing penetration of plating solution. The Ni plating layer can prevent the principal surface electrode 26 from being eroded by solder when mounting the multilayer ceramic capacitor 10. Furthermore, the Sn plating layer can improve wettability of the solder when mounting the multilayer ceramic capacitor 10 and can facilitate mounting.

Furthermore, as illustrated in FIG. 3 and FIG. 5, the plating layer 28 includes a cushion portion 40 protruding from the first principal surface 12a of the multilayer body 12 and a joint portion 42 protruding from the second principal surface 12b of the multilayer body 12. The cushion portion 40 is a structure with which a nozzle of a mounter comes into contact during mounting. In addition, the joint portion 42 is a structure where the multilayer ceramic capacitor 10 and a mounting substrate 50 are joined through a joint material 54 when mounting the multilayer ceramic capacitor 10 on the mounting substrate 50.

The cushion portion 40 is a structure that is disposed on the first principal surface 12a side and protrudes from the first principal surface 12a. The cushion portion 40 includes a first cushion portion 40a provided on the first plating layer 28a and a second cushion portion 40b provided on the second plating layer 28b.

It is preferable that a maximum distance in the laminating direction x by which the first cushion portion 40a protrudes from the first principal surface 12a of the multilayer body 12 be substantially the same as a maximum distance in the laminating direction x by which the second cushion portion 40b protrudes from the first principal surface 12a of the multilayer body 12.

The cushion portion 40 can be formed by plating growth from metal particles included in the inner electrode layer 16. More specifically, the cushion portion 40 is formed by metal being deposited in or on the same portions of the metal particles included in the inner electrode layer 16 that is exposed from the multilayer body 12 at each of the end surfaces 12e, 12f.

In addition, the joint portion 42 is a structure that is disposed on the second principal surface 12b side and protrudes from the second principal surface 12b. The joint portion 42 includes a first joint portion 42a provided on the first plating layer 28a and a second joint portion 42b provided on the second plating layer 28b.

The first joint portion 42a covers the first principal surface electrode 26a. In addition, the second joint portion 42b covers the second principal surface electrode 26b.

It is preferable that a maximum distance in the laminating direction x by which the first joint portion 42a protrudes from the second principal surface 12b of the multilayer body 12 be substantially the same as a maximum distance in the laminating direction x by which the second joint portion 42b protrudes from the second principal surface 12b of the multilayer body 12.

The joint portion 42 can be formed by plating growth from metal particles included in the inner electrode layer 16 and the principal surface electrode 26. More specifically, the joint portion 42 is formed by metal being deposited in or on the same portions of the metal particles included in the inner electrode layer 16 and the metal particles included in the principal surface electrode 26 that are exposed from the multilayer body 12 at the end surfaces 12e, 12f.

It is preferable that the cushion portion 40 and the joint portion 42 be provided continuously. That is, it is preferable that the first cushion portion 40a and the first joint portion 42a be provided continuously on the first end surface 12e. It is also preferable that the second cushion portion 40b and the second joint portion 42b be provided continuously on the second end surface 12f. With such a configuration, it is possible to ensure electrical connectivity.

The maximum distance in the laminating direction x by which the cushion portion 40 protrudes from the first principal surface 12a of the multilayer body 12 is t1. In addition, the maximum distance in the laminating direction x by which the joint portion 42 protrudes from the second principal surface 12b of the multilayer body 12 is t2. The maximum distance (t1) in the laminating direction x by which the cushion portion 40 protrudes from the first principal surface 12a of the multilayer body 12 is longer than the maximum distance (t2) in the laminating direction x by which the joint portion 42 protrudes from the second principal surface 12b of the multilayer body 12. With such a configuration, the nozzle of the mounter hits the cushion portion 40 which can then absorb stress on the multilayer body 12 like a cushion. This makes it possible to further alleviate stress on the multilayer body 12.

It is preferable that the maximum distance (t1) in the laminating direction x by which the cushion portion 40 protrudes from the first principal surface 12a of the multilayer body 12 be about 5 μm or more and about 10 μm or less, for example. With such a configuration, it is possible to further alleviate the stress caused by the nozzle of the mounter during mounting.

Here, the maximum distance (t1) in the laminating direction x by which the cushion portion 40 protrudes from the first principal surface 12a of the multilayer body 12 can be calculated by performing cross-sectional polishing up to one-half of the dimension W in the width direction y of the multilayer ceramic capacitor 10 (½ LT cross section), observing the cross section at a magnification of 1000 times or more and 3000 times or less using a scanning electron microscope (SEM), and measuring a distance between the first principal surface 12a and the apex of the cushion portion 40.

In addition, the maximum distance (t2) in the laminating direction x by which the joint portion 42 protrudes from the second principal surface 12b of the multilayer body 12 can be calculated by performing cross-sectional polishing up to one-half of the dimension W in the width direction y of the multilayer ceramic capacitor 10 (½ LT cross section), observing the cross section at a magnification of 1000 times or more and 3000 times or less using a scanning electron microscope (SEM), and measuring a distance between the second principal surface 12b and the apex of the joint portion 42.

A dimension in the length direction z of the multilayer ceramic capacitor 10 including the multilayer body 12, the first outer electrode 24a, and the second outer electrode 24b is dimension L. A dimension in the laminating direction x of the multilayer ceramic capacitor 10 including the multilayer body 12, the first outer electrode 24a, and the second outer electrode 24b is dimension T. A dimension in the width direction y of the multilayer ceramic capacitor 10 including the multilayer body 12, the first outer electrode 24a, and the second outer electrode 24b is dimension W.

It is preferable that the multilayer ceramic capacitor 10 have the dimension L in the length direction z of about 0.2 mm or more and about 3.2 mm or less, the dimension W in the width direction y of about 0.1 mm or more and about 2.5 mm or less, and the dimension T in the laminating direction x of about 0.04 mm or more and about 0.30 mm or less, for example.

As illustrated in FIG. 5, the multilayer ceramic capacitor according to the first example embodiment is sucked using a mounter nozzle 60 and mounted on the mounting substrate 50. The mounting substrate 50 includes a substrate core material 51 and a conductor land 52. The substrate core material 51 is configured, for example, as a substrate that is made of a material obtained by impregnating a base material of mixed glass fabric (cloth) and glass unwoven fabric with epoxy resin or polyimide resin, or as a ceramic substrate manufactured by baking a sheet obtained by mixing ceramics and glass. Note that the substrate core material 51 may be a substrate of a single layer or may be configured as a substrate made by laminating a plurality of layers.

One principal surface of the substrate core material 51 is a substrate-side mounting surface 51a where the conductor land 52 is placed and that serves as a mounting surface for the multilayer ceramic capacitor 10.

The conductor land 52 includes a first conductor land 52a and a second conductor land 52b. The first conductor land 52a is a site that is electrically coupled to the first outer electrode 24a of the multilayer ceramic capacitor 10 by the joint material 54 and is mechanically joined. The second conductor land 52b is a site that is electrically coupled to the second outer electrode 24b of the multilayer ceramic capacitor 10 by the joint material 54 and is mechanically joined.

The material of the conductor land 52 is not particularly limited, but metals such as copper, gold, palladium, platinum, or the like can be used. In addition, a thickness of the conductor land 52, that is, a dimension in the laminating direction x is not particularly limited but is preferably about 20 μm or more and about 200 μm or less, for example. As the joint material 54, for example, solder can be used.

The multilayer ceramic capacitor 10 is mounted on the mounting substrate 50 so that the second principal surface 12b faces the substrate-side mounting surface 51a. That is, the joint portion 42 provided on the plating layer 28 of the multilayer ceramic capacitor 10 is joined to the mounting substrate 50 with the joint material 54 interposed therebetween.

In this manner, if the multilayer ceramic capacitor 10 is sucked by the mounter nozzle 60 during mounting, the cushion portion 40 provided on the plating layer 28 of the multilayer ceramic capacitor 10 comes into contact with the mounter nozzle 60. Because the cushion portion 40 is made of metal that is a material softer than the multilayer body 12, the cushion portion 40 acts as a buffer material and can alleviate the impact of the mounter nozzle 60. In addition, when the multilayer ceramic capacitor 10 is mounted on the mounting substrate 50, the joint portion 42 of the multilayer ceramic capacitor 10 first comes into contact with the mounting substrate 50, so that it is possible to alleviate the stress on the middle-side end portion of the outer electrode 24 of the multilayer ceramic capacitor 10.

In the following, a description will be given of a non-limiting example of a method for manufacturing the multilayer ceramic capacitor 10 according to the first example embodiment.

First, a ceramic green sheet and conductive paste for the inner electrode layer are prepared. The ceramic green sheet or the conductive paste for the inner electrode layer includes a binder (for example, a publicly known organic binder) and a solvent (for example, a publicly known organic solvent).

Next, the conductive paste for the inner electrode layer is printed in a predetermined pattern on the ceramic green sheet using, for example, screen printing or gravure printing, to form the pattern of the inner electrode layer. Specifically, a conductive paste layer is formed by applying a paste made of a conductive material to the ceramic green sheet using a method such as the printing method described above. The paste made of a conductive material is, for example, a paste made by adding an organic binder and an organic solvent to metal powder. Note that for the ceramic green sheet, a ceramic green sheet for an outer layer on which no pattern for the inner electrode layer is printed is also produced.

A laminated sheet is produced using the ceramic green sheet on which the pattern for the inner electrode layer is formed. That is, a predetermined number of the ceramic green sheets for the outer layer on which no pattern for the inner electrode layer is formed are laminated. Then, ceramic green sheets on which the pattern for the inner electrode layer corresponding to the first inner electrode layer 16a is formed and ceramic green sheets on which the pattern for the inner electrode layer corresponding to the second inner electrode layer 16b is formed are alternately laminated. A predetermined number of the ceramic green sheets for the outer layer on which no pattern for the inner electrode layer is formed are further laminated thereon to produce a laminated sheet.

Furthermore, the laminated sheet is pressed in the laminating direction by, for example, a hydrostatic press and the like, to produce a multilayer block.

Then, the multilayer block is cut to a predetermined size to produce multilayer chips. At this time, corner portions and ridge portions of the multilayer chips may be rounded by barrel polishing and the like.

Next, the multilayer chips are fired to produce the multilayer body 12. Firing temperature depends on the dielectric material or the material of the inner electrode layer but is preferably about 900° C. or more and about 1400° C. or less, for example.

Then, the principal surface electrode 26 includes a thin film layer on a portion of the second principal surface 12b of the multilayer body 12 and on a portion of the first end surface 12e or the second end surface 12f. The principal surface electrode 26 can be formed by, for example, the sputtering method and the like. In other words, the principal surface electrode 26 includes a sputtered electrode. The sputtered electrode may include a metal including at least one of Ni, Cr, Cu, or Ti, or the like.

Thereafter, the plating layer 28 is formed so as to directly cover the principal surface electrode 26 as well as the first end surface 12e and the second end surface 12f of the multilayer body 12 on which the principal surface electrode 26 is not placed. The plating layer 28 includes at least one of Cu, Ni, Sn, Ag, Pd, an Ag-Pd alloy, or Au, or the like, and includes a single layer or a plurality of layers. It is preferable that the plating layer 28 include, for example, at least one of a Cu plating layer, a Ni plating layer, or a Sn plating layer. When the plating layer 28 is formed, electrolytic plating using an electrolytic bath to which an additive has been added or electroless plating using a substitution reaction is performed. Here, the distance in the laminating direction x of the cushion portion 40 and the joint portion 42 can be adjusted by varying plating conditions (temperature or time of the plating bath and the like).

In this manner, the multilayer ceramic capacitor 10 according to this example embodiment can be manufactured.

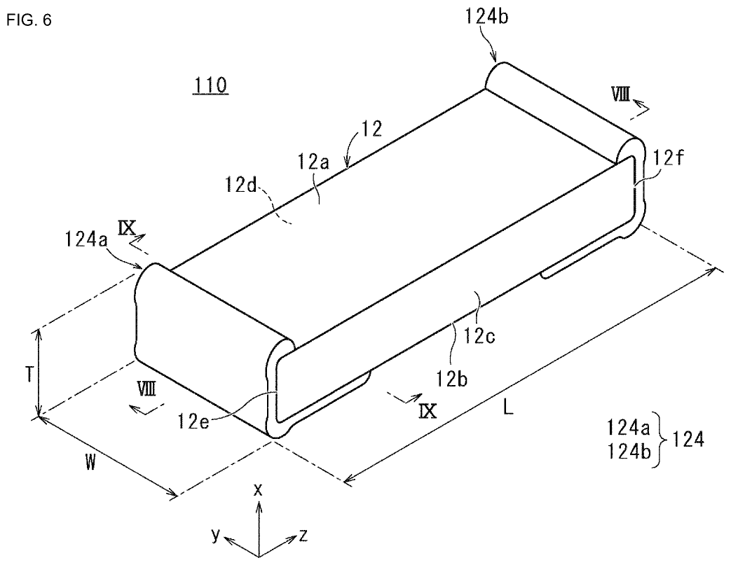

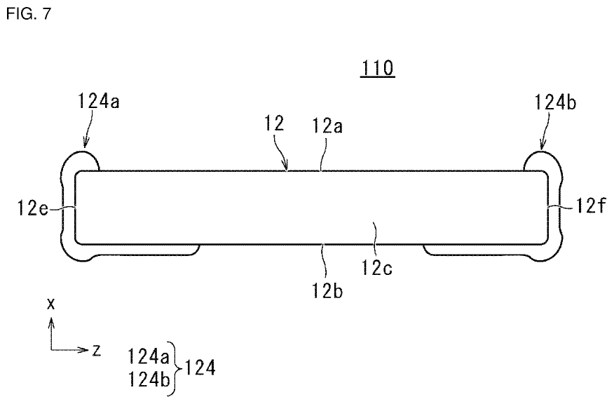

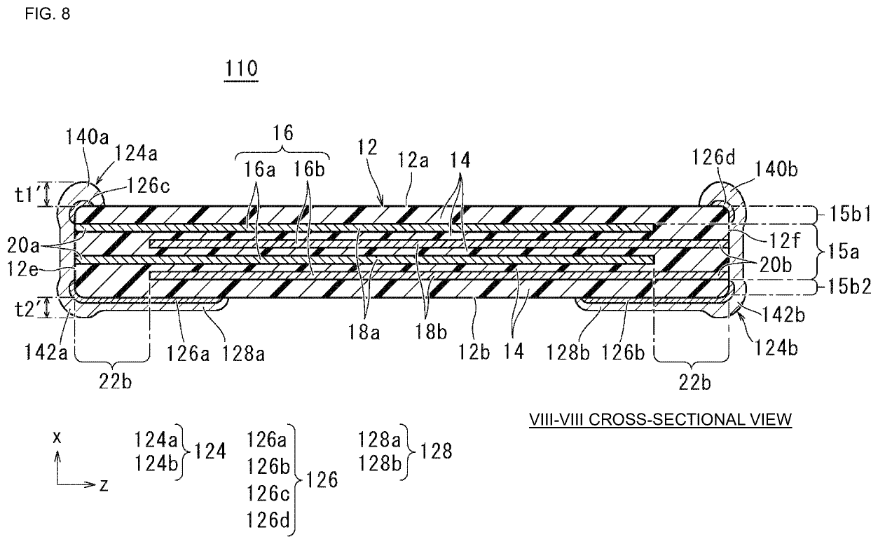

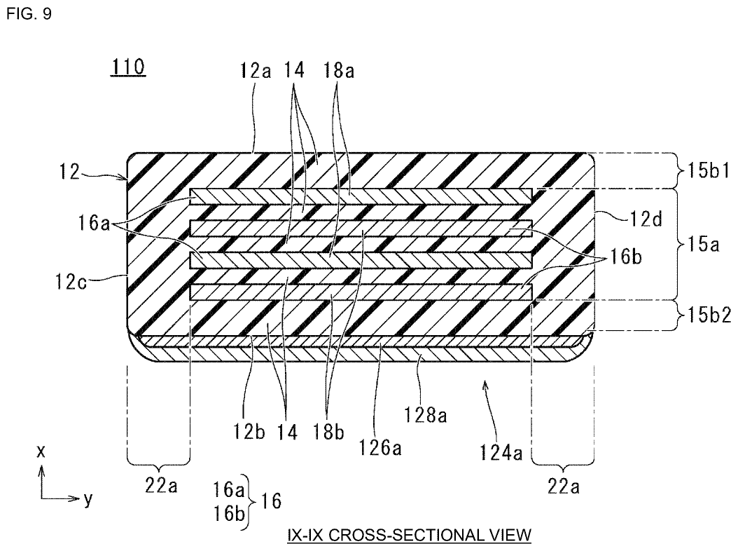

A description will be given of a multilayer ceramic capacitor 110 according to a second example embodiment of the present invention. FIG. 6 is an external perspective view illustrating a multilayer ceramic capacitor according to the second example embodiment of the present invention. FIG. 7 is a front view of the multilayer ceramic capacitor according to the second example embodiment of the present invention. FIG. 8 is a cross-sectional view taken along line VIII-VIII in FIG. 6. FIG. 9 is a cross-sectional view taken along line IX-IX in FIG. 6.

The multilayer ceramic capacitor 110 according to the second example embodiment includes the multilayer body 12 of the multilayer ceramic capacitor 10 according to the first example embodiment and an outer electrode 124. As illustrated in FIG. 8, a principal surface electrode 126 of the outer electrode 124 is disposed on the ridge portion where the second principal surface 12b is connected to the first end surface 12e and the second end surface 12f, and on the ridge portion where the first principal surface 12a is connected to the first end surface 12e and the second end surface 12f. Therefore, the same reference numerals are assigned to those corresponding to the components of the above-described example embodiment and a detailed description thereof will be omitted.

The multilayer body 12 of the multilayer ceramic capacitor 110 according to the second example embodiment has a configuration similar to that of the multilayer ceramic capacitor according to the first example embodiment. In the multilayer body 12 of the multilayer ceramic capacitor 110 according to the second example embodiment, however, the first end surface 12e and the second end surface 12f are not curved from the first principal surface 12a to the second principal surface 12b.

As illustrated in FIG. 6 to FIG. 8, the outer electrode 124 is disposed on the first end surface 12e side and the second end surface 12f side of the multilayer body 12.

The outer electrode 124 includes a first outer electrode 124a and a second outer electrode 124b.

The first outer electrode 124a is disposed on the first end surface 12e and the second principal surface 12b of the multilayer body 12. In this case, the first outer electrode 124a is electrically coupled to the first lead-out electrode portion 20a of the first inner electrode layer 16a.

The second outer electrode 124b is disposed on the second end surface 12f and the second principal surface 12b of the multilayer body 12. In this case, the second outer electrode 124b is electrically coupled to the second lead-out electrode portion 20b of the second inner electrode layer 16b.

Within the multilayer body 12, electrostatic capacitance is generated by the first opposing electrode portion 18a of the first inner electrode layer 16a and the second opposing electrode portion 18b of the second inner electrode layer 16b facing each other with the dielectric layer 14 interposed therebetween. As a result, it is possible to obtain electrostatic capacitance between the first outer electrode 124a to which the first inner electrode layer 16a is coupled and the second outer electrode 124b to which the second inner electrode layer 16b is coupled, and capacitor characteristics are exhibited.

The outer electrode 124 includes the principal surface electrode 126 and a plating layer 128 configured to cover the principal surface electrode 126. More specifically, the first outer electrode 124a includes a first principal surface electrode 126a disposed on the first end surface 12e and the second principal surface 12b, a third principal surface electrode 126c disposed on the first end surface 12e and the first principal surface 12a, and a first plating layer 128a that covers the first principal surface electrode 126a and the third principal surface electrode 126c and is disposed on the first end surface 12e and the second principal surface 12b. In addition, the second outer electrode 124b includes a second principal surface electrode 126b disposed on the second end surface 12f and the second principal surface 12b, a fourth principal surface electrode 126d disposed on the second end surface 12f and the first principal surface 12a, and a second plating layer 128b that covers the second principal surface electrode 126b and the fourth principal surface electrode 126d and is disposed on the second end surface 12f and the second principal surface 12b.

The principal surface electrode 126 includes the first principal surface electrode 126a, the second principal surface electrode 126b, the third principal surface electrode 126c, and the fourth principal surface electrode 126d.

The first principal surface electrode 126a extends from the ridge portion to which the first end surface 12e and the second principal surface 12b of the multilayer body 12 are connected, to the first end surface 12e and the second principal surface 12b of the multilayer body 12, and is configured to cover a portion of the first end surface 12e and the second principal surface 12b. The second principal surface electrode 126b extends from the ridge portion to which the second end surface 12f and the second principal surface 12b of the multilayer body 12 are connected, to the second end surface 12f and the second principal surface 12b of the multilayer body 12, and is configured to cover a portion of the second end surface 12f and the second principal surface 12b of the multilayer body 12.

In addition, the third principal surface electrode 126c extends from the ridge portion to which the first end surface 12e and the first principal surface 12a of the multilayer body 12 are connected, to the first end surface 12e and the first principal surface 12a, and is configured to cover a portion of the first end surface 12e and the first principal surface 12a. The fourth principal surface electrode 126d extends from the ridge portion to which the second end surface 12f and the first principal surface 12a of the multilayer body 12 are connected, to the second end surface 12f and the first principal surface 12a, and is configured to cover a portion of the second end surface 12f and the first principal surface 12a of the multilayer body 12.

An area of the first end surface 12e covered by the third principal surface electrode 126c is smaller than an area of the first end surface 12e covered by the first principal surface electrode 126a. In addition, an area of the second end surface 12f covered by the fourth principal surface electrode 126d is smaller than an area of the second end surface 12f covered by the second principal surface electrode 126b. With such a configuration, formation of the plating layer 128 is facilitated in the ridge portion of the multilayer body 12 that is a portion where no inner electrode layer 16 is exposed. In addition, on the plating layer 128, plating tends to be formed uniformly on a portion where the principal surface electrode 126 is formed. Therefore, by making the area of the first end surface 12e or the second end surface 12f covered by the third principal surface electrode 126c and the fourth principal surface electrode 126d disposed on the first principal surface 12a side smaller than the area of the first end surface 12e or the second end surface 12f covered by the first principal surface electrode 126a and the second principal surface electrode 126b disposed on the second principal surface 12b side, it is possible to make the plating layer 128 on the second principal surface 12b side, which is the mounting surface side, flatter than the plating layer 128 on the first principal surface 12a side. This further makes it easier to mount the multilayer ceramic capacitor 110.

It is preferable that the principal surface electrode 126 be formed by the thin film forming method such as the sputtering method or the vapor deposition method, or the like. In particular, it is preferable that the principal surface electrode 126 be a sputtered electrode formed by the sputtering method.

It is preferable that, as the principal surface electrode 126, a sputtered electrode be directly formed on a portion of the second principal surface 12b of the multilayer body 12, and on a portion of the first end surface 12e or a portion of the second end surface 12f. The principal surface electrode 126 includes at least one of Ni, Cr, Cu, Ti, or the like.

The principal surface electrode 126 may also include metals, such as Ni, Cu, Ag, Pd, an Ag-Pd alloy, or Au, for example. At this time, it is preferable that the principal surface electrode 126 include, as a co-material, the same dielectric material as the dielectric ceramic included in the dielectric layer 14. By including the co-material, the shrink behavior of the principal surface electrode 126 during firing can be made closer to the shrink behavior of the multilayer body 12, which thus makes it possible to prevent the peeling of the principal surface electrode 126 from the multilayer body 12.

The plating layer 128 includes the first plating layer 128a and the second plating layer 128b.

The first plating layer 128a covers the first principal surface electrode 126a and the third principal surface electrode 126c. The second plating layer 128b covers the second principal surface electrode 126b and the fourth principal surface electrode 126d.

The plating layer 128 includes, for example, at least one of Ni, Sn, Cu, Ag, Pd, an Ag-Pd alloy, or Au, or the like. It is preferable that the plating layer 128 include, for example, at least one of a Cu plating layer, a Ni plating layer, or a Sn plating layer.

The plating layer 128 may include a plurality of layers.

For example, in a case where the plating layer 128 has a two-layer structure, the plating layer 128 includes a Ni plating layer covering the principal surface electrode 126 and a Sn plating layer configured to cover the Ni plating layer.

In addition, for example, in a case where the plating layer 128 has a three-layer structure, the plating layer 128 includes a Cu plating layer covering the principal surface electrode 126, a Ni plating layer configured to cover the Cu plating layer, and a Sn plating layer configured to cover the Ni plating layer.

By being provided so as to cover a surface of the principal surface electrode 126, the Cu plating layer has the effect of reducing or preventing penetration of plating solution. The Ni plating layer can prevent the principal surface electrode 126 from being eroded by solder when mounting the multilayer ceramic capacitor 110. Furthermore, the Sn plating layer can improve the wettability of the solder when mounting the multilayer ceramic capacitor 110 and can facilitate mounting.

Furthermore, as illustrated in FIG. 8, the plating layer 128 includes a cushion portion 140 and a joint portion 142. The cushion portion 140 is a structure with which a nozzle of a mounter comes into contact during mounting. In addition, the joint portion 142 is a structure where the multilayer ceramic capacitor 110 and a substrate (not illustrated) are joined through a joint material when mounting the multilayer ceramic capacitor 110 on the substrate.

The cushion portion 140 is a structure that is disposed on the first principal surface 12a side and protrudes from the first principal surface 12a. The cushion portion 140 includes a first cushion portion 140a provided on the first plating layer 128a and a second cushion portion 140b provided on the second plating layer 128b.

The first cushion portion 140a covers the third principal surface electrode 126c. In addition, the second cushion portion 140b covers the fourth principal surface electrode 126d.

The cushion portion 140 can be formed by plating growth from metal particles included in the inner electrode layer 16, the third principal surface electrode 126c, and the fourth principal surface electrode 126d. More specifically, the metal included in the plating layer 128 easily adheres to the metal particles that are included in the first inner electrode layer 16a exposed at the first end surface 12e from the multilayer body 12 and to the third principal surface electrode 126c, so that the metal is deposited in or on the same portions to thus provide first cushion portion 140a. In addition, the metal included in the plating layer 128 easily adheres to the metal particles that are included in the second inner electrode layer 16b exposed at the second end surface 12f from the multilayer body 12 and to the fourth principal surface electrode 126d, and the plating is deposited in or on the same portions to thus provide the second cushion portion 140b.

In addition, the joint portion 142 is a structure that is disposed on the second principal surface 12b side and protrudes from the second principal surface 12b. The joint portion 142 includes a first joint portion 142a provided on the first plating layer 128a and a second joint portion 142b provided on the second plating layer 128b.

The first joint portion 142a covers the first principal surface electrode 126a. In addition, the second joint portion 142b covers the second principal surface electrode 126b.

The joint portion 142 can be formed by plating growth from metal particles included in the inner electrode layer 16, the first principal surface electrode 126a, and the second principal surface electrode 126b. More specifically, the metal included in the plating layer 128 easily adheres to the metal particles that are included in the first inner electrode layer 16a exposed at the first end surface 12e from the multilayer body 12 and to the first principal surface electrode 126a, and the metal is deposited in or on the same portions to thus provide first joint portion 142a. In addition, the metal included in the plating layer 128 easily adheres to the metal particles that are included in the second inner electrode layer 16b exposed at the second end surface 12f from the multilayer body 12 and to the second principal surface electrode 126b, and the metal is deposited in or on the same portions to thus provide second joint portion 142b.

It is preferable that the cushion portion 140 and the joint portion 142 be provided continuously. That is, it is preferable that the first cushion portion 140a and the first joint portion 142a be provided continuously on the first end surface 12e. It is also preferable that the second cushion portion 140b and the second joint portion 142b be provided continuously on the second end surface 12f. With such a configuration, it is possible to ensure the electrical connectivity.

The maximum distance in the laminating direction x by which the cushion portion 140 protrudes from the first principal surface 12a of the multilayer body 12 is t1′. In addition, the maximum distance in the laminating direction x by which the joint portion 142 protrudes from the second principal surface 12b of the multilayer body 12 is t2′. The maximum distance (t1′) in the laminating direction x by which the cushion portion 140 protrudes from the first principal surface 12a of the multilayer body 12 is longer than the maximum distance (t2′) in the laminating direction x by which the joint portion 142 protrudes from the second principal surface 12b of the multilayer body 12. With such a configuration, the nozzle of the mounter hits the cushion portion 140 which can then absorb stress on the multilayer body 12 like a cushion. This makes it possible to further alleviate stress on the multilayer body 12.

It is preferable that the maximum distance (t1′) in the laminating direction x by which the cushion portion 140 protrudes from the first principal surface 12a of the multilayer body 12 be about 5μm or more and about 10μm or less, for example. With such a configuration, it is possible to further alleviate the stress caused by the nozzle of the mounter during mounting.

Here, the maximum distance (t1′) in the laminating direction x by which the cushion portion 140 protrudes from the first principal surface 12a of the multilayer body 12 can be calculated by performing cross-sectional polishing up to one-half of the dimension W in the width direction y of the multilayer ceramic capacitor 110 (½ LT cross section), observing the cross section at a magnification of 2000 times using a scanning electron microscope (SEM), and measuring a distance between the first principal surface 12a and the apex of the cushion portion 140.

In addition, the maximum distance (t2′) in the laminating direction x by which the joint portion 142 protrudes from the second principal surface 12b of the multilayer body 12 can be calculated by performing cross-sectional polishing up to one-half of the dimension W in the width direction y of the multilayer ceramic capacitor 110 (½ LT cross section), observing the cross section at a magnification of 2000 times using a scanning electron microscope (SEM), and measuring a distance between the second principal surface 12b and the apex of the joint portion 142.

A dimension in the length direction z of the multilayer ceramic capacitor 110 including the multilayer body 12, the first outer electrode 124a, and the second outer electrode 124b is dimension L. A dimension in the laminating direction x of the multilayer ceramic capacitor 110 including the multilayer body 12, the first outer electrode 124a, and the second outer electrode 124b is dimension T. A dimension in the width direction y of the multilayer ceramic capacitor 110 including the multilayer body 12, the first outer electrode 124a, and the second outer electrode 124b is dimension W.

It is preferable that the multilayer ceramic capacitor 110 have the dimension L in the length direction z of about 0.2 mm or more and about 3.2 mm or less, the dimension W in the width direction y of about 0.1 mm or more and about 2.5 mm or less, and the dimension T in the laminating direction x of about 0.04 mm or more and about 0.30 mm or less, for example.

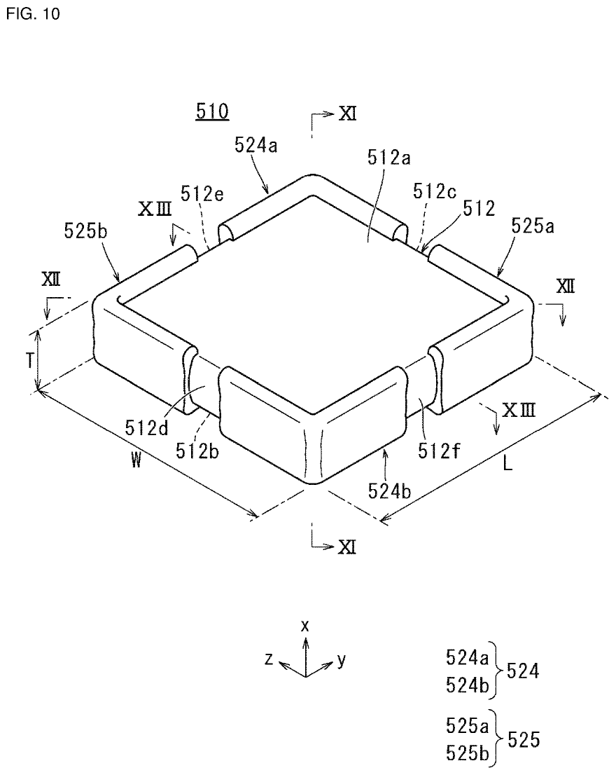

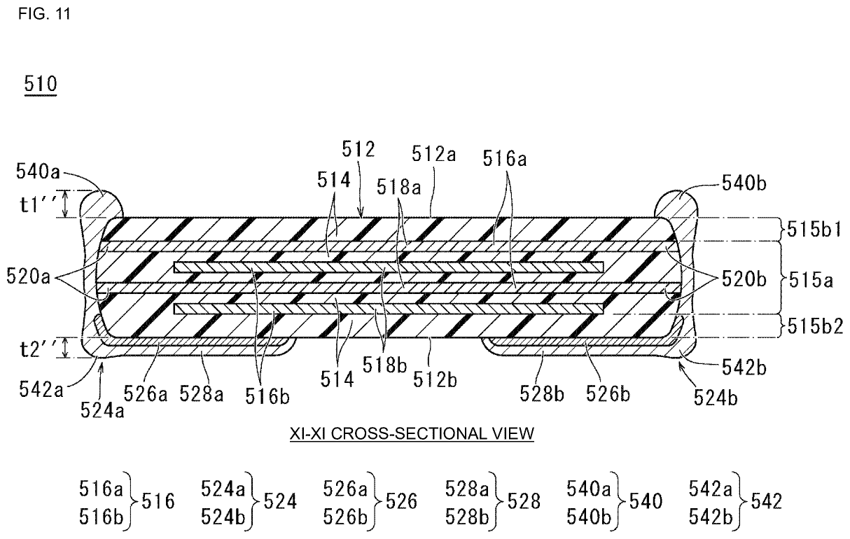

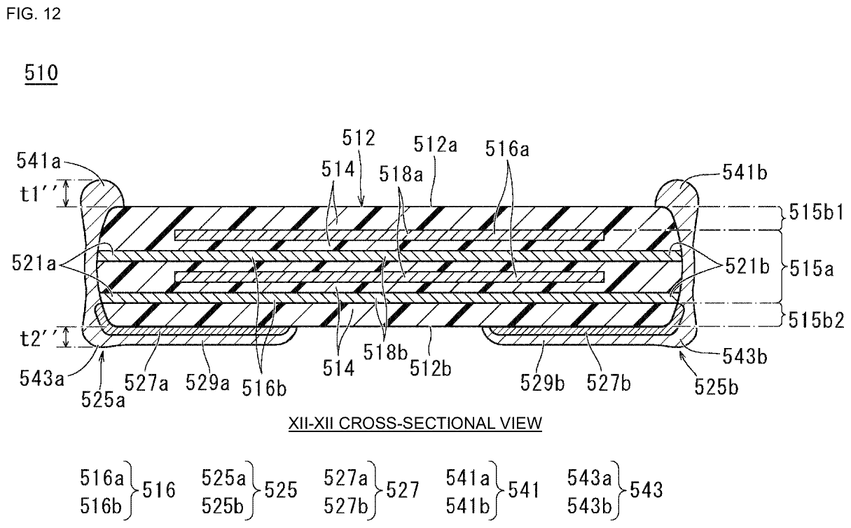

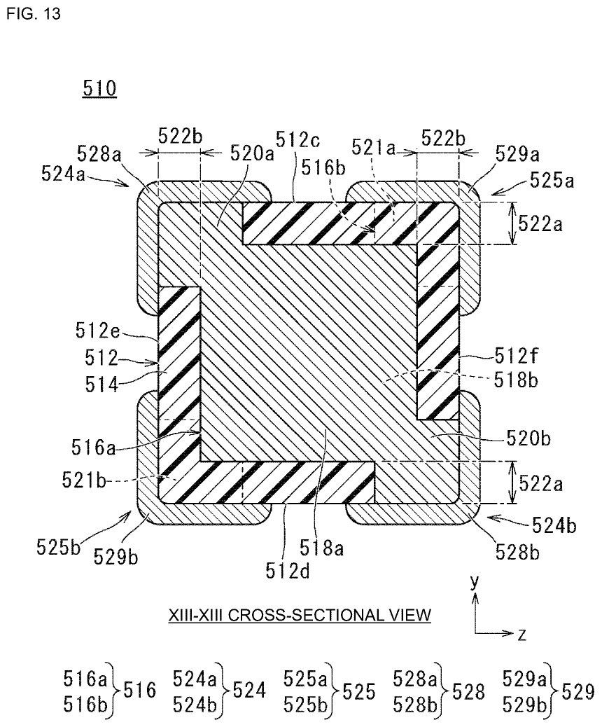

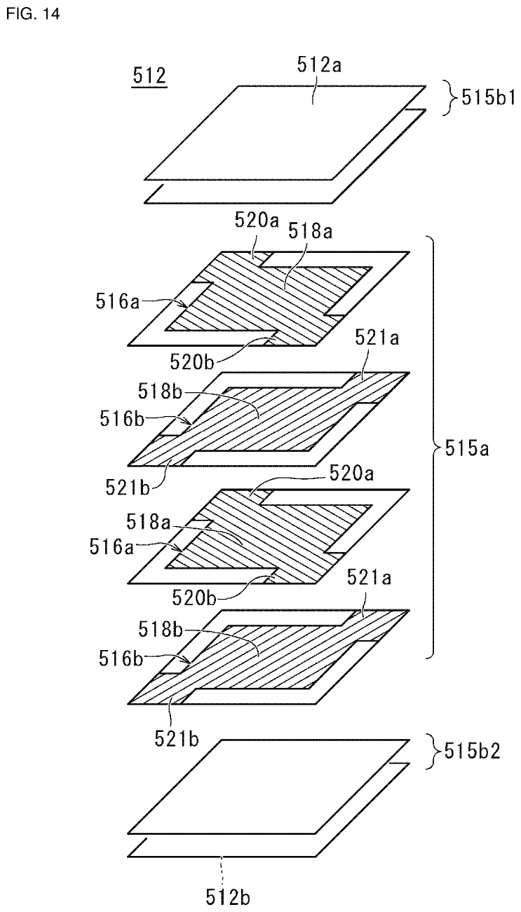

A description will be given of a multilayer ceramic capacitor 510 according to a third example embodiment of the present invention. FIG. 10 is an external perspective view illustrating a multilayer ceramic capacitor according to the third example embodiment of the present invention. FIG. 11 is a cross-sectional view along line XI-XI in FIG. 10. FIG. 12 is a cross-sectional view along line XII-XII in FIG. 10. FIG. 13 is a cross-sectional view along line XIII-XIII in FIG. 10. FIG. 14 is an exploded perspective view of a multilayer body illustrated in FIG. 10.

The multilayer ceramic capacitor 510 includes a multilayer body 512 and outer electrodes 524, 525.

The multilayer body 512 includes a plurality of dielectric layers 514 and a plurality of inner electrode layers 516. The multilayer body 512 has a first principal surface 512a and a second principal surface 512b that face each other in the laminating direction x, a first side surface 512c and a second side surface 512d that face each other in a width direction y orthogonal to the laminating direction x, and a third side surface 512e and a fourth side surface 512f that face each other in a length direction z orthogonal to the laminating direction x and the width direction y.

In addition, it is preferable that the multilayer body 512 have rounded corner portions and ridge portions. A corner portion refers to a portion where three adjacent surfaces of the multilayer body 512 intersect, and a ridge portion refers to a portion where two adjacent surfaces of the multilayer body 512 intersect. The second principal surface 512b side of the multilayer body 512 is a mounting surface.

As illustrated in FIG. 11 and FIG. 12, the multilayer body 512 includes, in the laminating direction x that connects the first principal surface 512a and the second principal surface 512b, an inner layer portion 515a, in which a plurality of inner electrode layers 516 face each other, a first outer layer portion 515b1 including the plurality of dielectric layers 514 located between the inner electrode layers 516 positioned closest to the first principal surface 512a side and the first principal surface 512a, and a second outer layer portion 515b2 including the plurality of dielectric layers 514 located between the inner electrode layers 516 positioned closest to the second principal surface 512b side and the second principal surface 512b.

The first outer layer portion 515b1 is a collection of the plurality of dielectric layers 514 located on the first principal surface 512a side of the multilayer body 512 and located between the first principal surface 512a and the inner electrode layer 516 positioned closest to the first principal surface 512a.

The second outer layer portion 515b2 is a collection of the plurality of dielectric layers 514 located on the second principal surface 512b side of the multilayer body 512 and located between the second principal surface 512b and the inner electrode layer 516 positioned closest to the second principal surface 512b.

Then, a region sandwiched between the first outer layer portion 515b1 and the second outer layer portion 515b2 is the inner layer portion 515a.

The dielectric layers 514 may include, for example, a dielectric material. As a dielectric material, a dielectric ceramic mainly including, for example, BaTiO₃, CaTiO₃, SrTiO₃, CaZrO₃, or the like, can be used. Alternatively, a dielectric material may also be used in which a subcomponent, such as a Mn compound, an Fe compound, a Cr compound, a Co compound, and a Ni compound is added to these main components.

It is preferable that the dielectric layer 514 have a thickness of about 0.3 μm or more and about 5.0 μm or less, for example. In addition, it is preferable that a total number of the dielectric layers 514 be 5 or more and 2000 or less, for example.

As illustrated in FIG. 11 and FIG. 12, the inner electrode layers 516 include a plurality of first inner electrode layers 516a and a plurality of second inner electrode layers 516b. The first inner electrode layers 516a and the second inner electrode layers 516b are alternately laminated with the dielectric layers 514 interposed therebetween.

The first inner electrode layer 516a is disposed on a surface of the dielectric layer 514. In addition, the first inner electrode layer 516a includes a first opposing electrode portion 518a that faces the first principal surface 512a and the second principal surface 512b and faces the second inner electrode layer 516b, and is laminated in a direction connecting the first principal surface 512a and the second principal surface 512b.

In addition, the second inner electrode layer 516b is disposed on a surface of the dielectric layer 514 that is different from the surface where the first inner electrode layer 516a is disposed. The second inner electrode layer 516b includes a second opposing electrode portion 518b that faces the first principal surface 512a and the second principal surface 512b, and is laminated in a direction connecting the first principal surface 512a and the second principal surface 512b.

As illustrated in FIG. 13, the first inner electrode layer 516a is drawn out to the first side surface 512c and the third side surface 512e of the multilayer body 512 by a first lead-out electrode portion 520a and drawn out to the second side surface 512d and the fourth side surface 512f of the multilayer body 512 by a second lead-out electrode portion 520b. Note that a length in the length direction z by which the first lead-out electrode portion 520a is drawn out to the first side surface 512c may be substantially equal to a length in the width direction y by which the first lead-out electrode portion 520a is drawn out to the third side surface 512e. A length in the length direction z by which the second lead-out electrode portion 520b is drawn out to the second side surface 512d may be substantially equal to a length in the width direction y by which the second lead-out electrode portion 520b is drawn out to the fourth side surface 512f.

The second inner electrode layer 516b is drawn out to the first side surface 512c and the fourth side surface 512f of the multilayer body 512 by a third lead-out electrode portion 521a and drawn out to the second side surface 512d and the third side surface 512e of the multilayer body 512 by a fourth lead-out electrode portion 521b. Note that a length in the length direction z by which the third lead-out electrode portion 521a is drawn out to the first side surface 512c may be substantially equal to a length in the width direction y by which the third lead-out electrode portion 521a is drawn out to the fourth side surface 512f. A length in the length direction z by which the fourth lead-out electrode portion 521b is drawn out to the second side surface 512d may be substantially equal to a length in the width direction y by which the fourth lead-out electrode portion 521b is drawn out to the third side surface 512e.

Furthermore, on the side surfaces 512c, 512d, 512e, 512f of the multilayer body 512, it is preferable that the first lead-out electrode portion 520a of the first inner electrode layer 516a and the fourth lead-out electrode portion 521b of the second inner electrode layer 516b be drawn out to positions facing each other, and that the second lead-out electrode portion 520b of the first inner electrode layer 516a and the third lead-out electrode portion 521a of the second inner electrode layer 516b be drawn out to positions facing each other.

In this example embodiment, the first inner electrode layer 516a is drawn out to the first side surface 512c and the third side surface 512e of the multilayer body 512 by the first lead-out electrode portion 520a and drawn out to the second side surface 512d and the fourth side surface 512f of the multilayer body 512 by the second lead-out electrode portion 520b. The second inner electrode layer 516b is drawn out to the first side surface 512c and the fourth side surface 512f of the multilayer body 512 by the third lead-out electrode portion 521a and drawn out to the second side surface 512d and the third side surface 512e of the multilayer body 512 by the fourth lead-out electrode portion 521b. However, the present invention is not limited to this. For example, the first inner electrode layer 516a may be drawn out to the first side surface 512c of the multilayer body 512 by the first lead-out electrode portion 520a and drawn out to the second side surface 512d of the multilayer body 512 by the second lead-out electrode portion 520b, and the second inner electrode layer 516b may be drawn out to the first side surface 512c of the multilayer body 512 by the third lead-out electrode portion 521a and drawn out to the second side surface 512d of the multilayer body 512 by the fourth lead-out electrode portion 521b.

Materials of the inner electrode layer 516 include, for example, Ni as a main component, and at least one of metals such as Cu, Ag, Pd, or Au or an alloy such as an Ag-Pd alloy, or the like. The inner electrode layer 516 may further include dielectric particles of the same composition system as the dielectric material included in the dielectric layer 514.

In addition, Sn may be included in the first inner electrode layer 516a and the second inner electrode layer 516b. By including Sn in the first inner electrode layer 516a and the second inner electrode layer 516b, it is possible to alleviate concentration of electric fields on an interface between the first inner electrode layer 516a and the second inner electrode layer 516b and the dielectric layer 514, which leads to improvement of the high temperature load reliability. At this time, Sn can be sufficiently effective even if Sn is included in only one of the first inner electrode layer 516a and the second inner electrode layer 516b.

It is preferable that a number of the inner electrode layers 516 be 5 or more and 2000 or less, for example. It is preferable that the inner electrode layer 516 have an average thickness of about 0.3 μm or more and about 1.0 μm or less, for example.

In addition, as illustrated in FIG. 13, the multilayer body 512 includes side portions (L gaps) 522b of the multilayer body 512 that are between one end in the length direction z of the first opposing electrode portion 518a and the third side surface 512e, and between another end in the length direction z of the second opposing electrode portion 518b and the fourth side surface 512f.

Furthermore, as illustrated in FIG. 13, the multilayer body 512 includes side portions (W gaps) 522a of the multilayer body 512 that are between one end in the width direction y of the first opposing electrode portion 518a and the first side surface 512c, and between another end in the width direction y of the second opposing electrode portion 518b and the second side surface 512d.

In this example embodiment, it is preferable that the side surfaces 512c, 512d, 512e, 512f of the multilayer body 512 be curved from the first principal surface 512a to the second principal surface 512b. With such a configuration, at the side surfaces 512c, 512d, 512e, 512f of the multilayer body 512, the inner electrode layer 516 is not exposed at the middle side of the multilayer body 512 in the laminating direction x, and the inner electrode layer 516 can be exposed from the middle side of the multilayer body 512 in the laminating direction x toward the first principal surface 512a or the second principal surface 512b.

As illustrated in FIG. 10 to FIG. 13, the outer electrodes 524, 525 are disposed on the multilayer body 512.

The outer electrode 524 includes a first outer electrode 524a and a second outer electrode 524b.

The first outer electrode 524a covers the first lead-out electrode portion 520a on the first side surface 512c and the third side surface 512e, and covers a portion of the second principal surface 512b. The first outer electrode 524a is electrically coupled to the first lead-out electrode portion 520a of the first inner electrode layer 516a.

The second outer electrode 524b covers the second lead-out electrode portion 520b on the second side surface 512d and the fourth side surface 512f, and covers a portion of the second principal surface 512b. The second outer electrode 524b is electrically coupled to the second lead-out electrode portion 520b of the first inner electrode layer 516a.

The outer electrode 525 includes a third outer electrode 525a and a fourth outer electrode 525b.

The third outer electrode 525a covers the third lead-out electrode portion 521a on the first side surface 512c and the fourth side surface 512f, and covers a portion of the second principal surface 512b. The third outer electrode 525a is electrically coupled to the third lead-out electrode portion 521a of the second inner electrode layer 516b.

The fourth outer electrode 525b covers the fourth lead-out electrode portion 521b on the second side surface 512d and the third side surface 512e, and covers a portion of the second principal surface 512b. The fourth outer electrode 525b is electrically coupled to the fourth lead-out electrode portion 521b of the second inner electrode layer 516b.

Within the multilayer body 512, electrostatic capacitance is generated by the first opposing electrode portion 518a of the first inner electrode layer 516a and the second opposing electrode portion 518b of the second inner electrode layer 516b facing each other with the dielectric layer 514 interposed therebetween. As a result, it is possible to obtain electrostatic capacitance between the first outer electrode 524a and the second outer electrode 524b to which the first inner electrode layer 516a is coupled and the third outer electrode 525a and the fourth outer electrode 525b to which the second inner electrode layer 516b is coupled, and the capacitor characteristics are exhibited.

The outer electrode 524 includes a principal surface electrode 526 and a plating layer 528 configured to cover the principal surface electrode 526.

The outer electrode 525 includes a principal surface electrode 527 and a plating layer 529 configured to cover the principal surface electrode 527.

More specifically, the first outer electrode 524a includes a first principal surface electrode 526a disposed on the first side surface 512c, the third side surface 512e, and the second principal surface 512b, and a first plating layer 528a that covers the first principal surface electrode 526a and is disposed on the first side surface 512c, the third side surface 512e, and the second principal surface 512b.

In addition, the second outer electrode 524b includes a second principal surface electrode 526b disposed on the second side surface 512d, the fourth side surface 512f, and the second principal surface 512b, and a second plating layer 528b that covers the second principal surface electrode 526b and is disposed on the second side surface 512d, the fourth side surface 512f, and the second principal surface 512b.

In addition, the third outer electrode 525a includes a third principal surface electrode 527a disposed on the first side surface 512c, the fourth side surface 512f, and the second principal surface 512b, and a third plating layer 529a that covers the third principal surface electrode 527a and is disposed on the first side surface 512c, the fourth side surface 512f, and the second principal surface 512b.

In addition, the fourth outer electrode 525b includes a fourth principal surface electrode 527b disposed on the second side surface 512d, the third side surface 512e, and the second principal surface 512b, and a fourth plating layer 529b that covers the fourth principal surface electrode 527b and is disposed on the second side surface 512d, the third side surface 512e, and the second principal surface 512b.

The principal surface electrode 526 includes the first principal surface electrode 526a and the second principal surface electrode 526b.

The first principal surface electrode 526a is configured to cover a portion of the second principal surface 512b at the corner portion where the second principal surface 512b, the first side surface 512c, and the third side surface 512e intersect.

The second principal surface electrode 526b is configured to cover a portion of the second principal surface 512b at the corner portion where the second principal surface 512b, the second side surface 512d, and the fourth side surface 512f intersect.

The principal surface electrode 527 includes the third principal surface electrode 527a and the fourth principal surface electrode 527b.

The third principal surface electrode 527a is configured to cover a portion of the second principal surface 512b at the corner portion where the second principal surface 512b, the first side surface 512c, and the fourth side surface 512f intersect.

The fourth principal surface electrode 527b is configured to cover a portion of the second principal surface 512b at the corner portion where the second principal surface 512b, the second side surface 512d, and the third side surface 512e intersect.

It is preferable that the principal surface electrodes 526, 527 be formed by a thin film forming method such as a sputtering method or a vapor deposition method, or the like. In particular, it is preferable that the principal surface electrodes 526, 527 be sputtered electrodes formed by the sputtering method.

It is preferable that, as the principal surface electrodes 526, 527, sputtered electrodes be directly formed on a portion of the second principal surface 512b of the multilayer body 512. The principal surface electrodes 526, 527 include at least one of Ni, Cr, Cu, Ti, or the like.

The principal surface electrodes 526, 527 may also include metals, such as Ni, Cu, Ag, Pd, an Ag-Pd alloy, or Au, for example. At this time, it is preferable that the principal surface electrodes 526, 527 include, as a co-material, the same dielectric material as the dielectric ceramic included in the dielectric layer 514. By including the co-material, the shrink behavior of the principal surface electrodes 526, 527 during firing can be made closer to the shrink behavior of the multilayer body 512, which thus makes it possible to prevent peeling of the principal surface electrodes 526, 527 from the multilayer body 512.

The plating layer 528 includes the first plating layer 528a and the second plating layer 528b.

The first plating layer 528a covers the first principal surface electrode 526a. The second plating layer 528b covers the second principal surface electrode 526b.

The plating layer 529 includes the third plating layer 529a and the fourth plating layer 529b.

The third plating layer 529a covers the third principal surface electrode 527a. The fourth plating layer 529b covers the fourth principal surface electrode 527b.

The plating layers 528, 529 include, for example, at least one of Ni, Sn, Cu, Ag, Pd, an Ag-Pd alloy, or Au, or the like. It is preferable that the plating layers 528, 529 include, for example, at least one of a Cu plating layer, a Ni plating layer, or a Sn plating layer.

The plating layers 528, 529 may include a plurality of layers.

For example, in a case where the plating layers 528, 529 have a two-layer structure, the plating layers 528, 529 each include a Ni plating layer covering the principal surface electrodes 526, 527 and a Sn plating layer configured to cover the Ni plating layer.

In addition, for example, in a case where the plating layers 528, 529 have a three-layer structure, the plating layers 528, 529 each include a Cu plating layer covering the principal surface electrodes 526, 527, a Ni plating layer configured to cover the Cu plating layer, and a Sn plating layer configured to cover the Ni plating layer.

By being provided so as to cover a surface of the principal surface electrodes 526, 527, the Cu plating layer has the effect of reducing or preventing penetration of plating solution. The Ni plating layer can prevent the principal surface electrodes 526, 527 from being eroded by solder when mounting the multilayer ceramic capacitor 510. Furthermore, the Sn plating layer can improve the wettability of the solder when mounting the multilayer ceramic capacitor 510 and can facilitate mounting.

Furthermore, as illustrated in FIG. 11 and FIG. 12, the plating layers 528, 529 respectively include cushion portions 540, 541 and joint portions 542, 543. The cushion portions 540, 541 are parts with which a nozzle of a mounter comes into contact during mounting. In addition, the joint portions 542, 543 are parts where the multilayer ceramic capacitor 510 and a substrate (not illustrated) are joined through a joint material when mounting the multilayer ceramic capacitor 510 on the substrate.

The cushion portion 540 is a structure that is disposed on the first principal surface 512a side and protrudes from the first principal surface 512a. The cushion portion 540 includes a first cushion portion 540a provided on the first plating layer 528a and a second cushion portion 540b provided on the second plating layer 528b.

The cushion portion 541 is a structure that is disposed on the first principal surface 512a side and protrudes from the first principal surface 512a. The cushion portion 541 includes a third cushion portion 541a provided on the third plating layer 529a and a fourth cushion portion 541b provided on the fourth plating layer 529b.

It is preferable that a maximum distance in the laminating direction x by which the first cushion portion 540a protrudes from the first principal surface 512a of the multilayer body 512, a maximum distance in the laminating direction x by which the second cushion portion 540b protrudes from the first principal surface 512a of the multilayer body 512, a maximum distance in the laminating direction x by which the third cushion portion 541a protrudes from the first principal surface 512a of the multilayer body 512, and a maximum distance in the laminating direction x by which the fourth cushion portion 541b protrudes from the first principal surface 512a of the multilayer body 512 be substantially identical.

The cushion portions 540, 541 can be formed by plating growth from metal particles included in the inner electrode layer 516. More specifically, the metals included in the plating layers 528, 529 easily adhere to the metal particles that are included in the inner electrode layer 516 exposed at the respective side surfaces 512c, 512d, 512e, 512f from the multilayer body 512, so that the metals are deposited in or on the same portions to thus provide cushion portions 540, 541.

In addition, the joint portion 542 is a structure that is disposed on the second principal surface 512b side and protrudes from the second principal surface 512b. The joint portion 542 includes a first joint portion 542a provided on the first plating layer 528a and a second joint portion 542b provided on the second plating layer 528b. The first joint portion 542a covers the first principal surface electrode 526a. In addition, the second joint portion 542b covers the second principal surface electrode 526b.

The joint portion 543 is a structure that is disposed on the second principal surface 512b side and protrudes from the second principal surface 512b. The joint portion 543 includes a third joint portion 543a provided on the third plating layer 529a and a fourth joint portion 543b provided on the fourth plating layer 529b. The third joint portion 543a covers the third principal surface electrode 527a. In addition, the fourth joint portion 543b covers the fourth principal surface electrode 527b.

It is preferable that a maximum distance in the laminating direction x by which the first joint portion 542a protrudes from the second principal surface 512b of the multilayer body 512, a maximum distance in the laminating direction x by which the second joint portion 542b protrudes from the second principal surface 512b of the multilayer body 512, a maximum distance in the laminating direction x by which the third joint portion 543a protrudes from the second principal surface 512b of the multilayer body 512, and a maximum distance in the laminating direction x by which the fourth joint portion 543b protrudes from the second principal surface 512b of the multilayer body 512 be substantially identical.

The joint portions 542, 543 can be formed by plating growth from metal particles included in the inner electrode layer 516. More specifically, the metals included in the plating layers 528, 529 easily adhere to the metal particles that are included in the inner electrode layer 516 exposed at the respective side surfaces 512c, 512d, 512e, 512f from the multilayer body 512 and the metal particles included in the principal surface electrodes 526, 527, so that the metals are deposited in or on the same portions to thus provide joint portions 542, 543.

It is preferable that the cushion portions 540, 541 and the joint portions 542, 543 be provided continuously. That is, it is preferable that the first cushion portion 540a and the first joint portion 542a be provided continuously on the first side surface 512c and the third side surface 512e. It is also preferable that the second cushion portion 540b and the second joint portion 542b be provided continuously on the second side surface 512d and the fourth side surface 512f. It is preferable that the third cushion portion 541a and the third joint portion 543a be provided continuously on the first side surface 512c and the fourth side surface 512f. It is also preferable that the fourth cushion portion 541b and the fourth joint portion 543b be provided continuously on the second side surface 512d and the third side surface 512e. With such a configuration, it is possible to ensure the electrical connectivity.

The maximum distance in the laminating direction x by which the cushion portions 540, 541 protrude from the first principal surface 512a of the multilayer body 512 is t1″. In addition, the maximum distance in the laminating direction x by which the joint portions 542, 543 protrude from the second principal surface 512b of the multilayer body 512 is t2″. The maximum distance (t1″) in the laminating direction x by which the cushion portions 540, 541 protrude from the first principal surface 512a of the multilayer body 512 is longer than the maximum distance (t2″) in the laminating direction x by which the joint portions 542, 543 protrude from the second principal surface 512b of the multilayer body 512. With such a configuration, the nozzle of the mounter hits the cushion portions 540, 541 which can then absorb stress on the multilayer body 512 like a cushion, making it possible to further alleviate stress on the multilayer body 512.

It is preferable that the maximum distance (t1″) in the laminating direction x by which the cushion portions 540, 541 protrude from the first principal surface 512a of the multilayer body 512 be about 5 μm or more and about 10 μm or less, for example. With such a configuration, it is possible to further alleviate the stress caused by the nozzle of the mounter during mounting.

Here, the maximum distance (t1″) in the laminating direction x by which the cushion portions 540, 541 protrude from the first principal surface 512a of the multilayer body 512 can be calculated by performing cross-sectional polishing up to one-fourth of the dimension W in the width direction y of the multilayer ceramic capacitor 510 (¼ LT cross section) or performing cross-sectional polishing up to one-fourth of the dimension L in the length direction z of the multilayer ceramic capacitor 510 (¼ WT cross section), observing the cross section at the magnification of 2000 times using a scanning electron microscope (SEM), and measuring a distance between the first principal surface 512a and the apex of the cushion portion 540, 541.

In addition, the maximum distance (t2″) in the laminating direction x by which the joint portions 542, 543 protrude from the second principal surface 512b of the multilayer body 512 can be calculated by performing cross-sectional polishing up to one-fourth of the dimension W in the width direction y of the multilayer ceramic capacitor 510 (¼ LT cross section) or performing cross-sectional polishing up to one-fourth of the dimension L in the length direction z of the multilayer ceramic capacitor 510 (¼ WT cross section), observing the cross section at a magnification of 2000 times using a scanning electron microscope (SEM), and measuring a distance between the second principal surface 512b and the apex of the joint portions 542, 543.

A dimension in the length direction z of the multilayer ceramic capacitor 510 including the multilayer body 512 and the outer electrodes 524, 525 is dimension L. A dimension in the laminating direction x of the multilayer ceramic capacitor 510 including the multilayer body 512 and the outer electrodes 524, 525 is dimension T. A dimension in the width direction y of the multilayer ceramic capacitor 510 including the multilayer body 512 and the outer electrodes 524, 525 is dimension W.

It is preferable that the multilayer ceramic capacitor 510 have the dimension L in the length direction z of about 0.1 mm or more and about 6.0 mm or less, and the dimension W in the width direction y of about 0.1 mm or more and about 6.0 mm or less, for example. It is also preferable that about 7/10≤L/W≤about 10/7, for example. This will increase a degree of freedom in mounting so that a multilayer ceramic capacitor can be substantially tetragonally shaped.

In the following, a description will be given of a method for manufacturing the multilayer ceramic capacitor 510 according to the third example embodiment.

First, a ceramic green sheet and conductive paste for the inner electrode layer are prepared. The ceramic green sheet or the conductive paste for the inner electrode layer includes a binder (for example, a publicly known organic binder) and a solvent (for example, a publicly known organic solvent).

Next, the conductive paste for the inner electrode layer is printed in a predetermined pattern on the ceramic green sheet using, for example, screen printing or gravure printing, to form the pattern of the inner electrode layer as illustrated in FIG. 14. Specifically, a conductive paste layer is formed by applying a paste made of a conductive material to the ceramic green sheet using a method such as the printing method described above. The paste made of a conductive material is, for example, a paste made by adding an organic binder and an organic solvent to metal powder. Note that for the ceramic green sheet, a ceramic green sheet for an outer layer on which no pattern for the inner electrode layer is printed is also produced.

A laminated sheet is produced using the ceramic green sheet on which the pattern for the inner electrode layer is formed. That is, a predetermined number of the ceramic green sheets for the outer layer on which no pattern for the inner electrode layer is formed are laminated. Then, ceramic green sheets on which the pattern for the inner electrode layer corresponding to the first inner electrode layer 516a is formed and ceramic green sheets on which the pattern for the inner electrode layer corresponding to the second inner electrode layer 516b is formed are alternately laminated. A predetermined number of the ceramic green sheets on which no pattern for the inner electrode layer is formed are further laminated thereon to produce a laminated sheet.

Furthermore, the laminated sheet is pressed in the laminating direction by, for example, a hydrostatic press and the like, to produce a multilayer block.

Then, the multilayer block is cut to a predetermined size to cut out multilayer chips. At this time, corner portions and ridge portions of the multilayer chips may be rounded by barrel polishing and the like.

Next, the multilayer chips are fired to produce the multilayer body 512. Firing temperature depends on the dielectric material or the material of the inner electrode layer but is preferably about 900° C. or more and about 1400° C. or less, for example.

At this time, as illustrated in FIG. 13, the first lead-out electrode portion 520a of the first inner electrode layer 516a is exposed from the first side surface 512c and the third side surface 512e of the multilayer body 512, and the third lead-out electrode portion 521a of the second inner electrode layer 516b is exposed from the first side surface 512c and the fourth side surface 512f of the multilayer body 512. In addition, the second lead-out electrode portion 520b of the first inner electrode layer 516a is exposed from the second side surface 512d and the fourth side surface 512f of the multilayer body 512, and the fourth lead-out electrode portion 521b of the second inner electrode layer 516b is exposed from the second side surface 512d and the third side surface 512e of the multilayer body 512.

Then, as illustrated in FIG. 11 and FIG. 12, the principal surface electrodes 526, 527 made of thin film layers are formed on a portion of the second principal surface 512b of the multilayer body 512. The principal surface electrodes 526, 527 can be formed by, for example, the sputtering method and the like. In other words, the principal surface electrodes include sputtered electrodes. The sputtered electrodes may include a metal including at least one of Ni, Cr, Cu, or Ti, or the like.

Thereafter, the first plating layer 528a is configured to cover the first principal surface electrode 526a that is disposed on the first side surface 512c and the third side surface 512e of the multilayer body 512 where no principal surface electrode is placed and is further disposed on the second principal surface 512b, and the second plating layer 528b is configured to cover the second principal surface electrode 526b that is disposed on the second side surface 512d and the fourth side surface 512f of the multilayer body 512 where no principal surface electrode is placed and is further disposed on the second principal surface 512b.

In addition, the third plating layer 529a is configured to cover the third principal surface electrode 527a that is disposed on the first side surface 512c and the fourth side surface 512f of the multilayer body 512 where no principal surface electrode is placed and is further disposed on the second principal surface 512b, and the fourth plating layer 529b is configured to cover the fourth principal surface electrode 527b that is disposed on the second side surface 512d and the third side surface 512e of the multilayer body 512 where no principal surface electrode is placed and is further disposed on the second principal surface 512b.

The plating layers 528, 529 include at least one of Cu, Ni, Sn, Ag, Pd, an Ag-Pd alloy, or Au, or the like, and are including a single layer or a plurality of layers. It is preferable that the plating layers 528, 529 include, for example, at least one of a Cu plating layer, a Ni plating layer, or a Sn plating layer. When the plating layers 528, 529 are formed, electrolytic plating using an electrolytic bath to which an additive has been added or electroless plating using a substitution reaction is performed. Here, the distance in the laminating direction x of the cushion portions 540, 541 and the joint portions 542, 543 can be adjusted by varying plating conditions (temperature or time of the plating bath and the like).

In this manner, the multilayer ceramic capacitor 510 according to this example embodiment can be manufactured.

Note that although the example embodiments of the present invention have been disclosed as described above, the present invention is not limited thereto.

In other words, various modifications can be made to the above-described example embodiments in terms of mechanism, shape, material, quantity, position, or arrangement, or the like, without departing from the scope of the technical ideas of example embodiments of the present invention, and the modifications fall within the scope of the present invention.

For example, although the above-described example embodiments describe only the multilayer ceramic capacitors that are symmetrical in front view, the external shape of the multilayer ceramic capacitor according to other example embodiments of the present invention may be modified in various ways, depending on an object to be mounted and desired performance as well.

Example embodiments of the present invention relate to a multilayer ceramic capacitor, and may be used effectively, particularly when mounting the multilayer ceramic capacitor on a mounting substrate using a mounter.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers and a plurality of inner electrode layers that are laminated, a first principal surface and a second principal surface that face each other in a laminating direction, a first side surface and a second side surface that face each other in a width direction orthogonal to the laminating direction, and a first end surface and a second end surface that face each other in a length direction orthogonal to the laminating direction and the width direction;
a first outer electrode coupled to one of the inner electrode layers and located on the first end surface and the second principal surface; and
a second outer electrode coupled to one of the inner electrode layers and located on the second end surface and the second principal surface; wherein the second principal surface of the multilayer body is a mounting surface;
the first outer electrode includes:
a first principal surface electrode located on the first end surface and the second principal surface; and
a first plating layer covering the first principal surface electrode and located on the first end surface and the second principal surface;
the second outer electrode includes:
a second principal surface electrode located on the second end surface and the second principal surface; and
a second plating layer covering the second principal surface electrode and located on the second end surface and the second principal surface;
the first plating layer and the second plating layer each include a cushion portion protruding from the first principal surface of the multilayer body and a joint portion protruding from the second principal surface of the multilayer body; and
a maximum distance in the laminating direction by which the cushion portion protrudes from the first principal surface of the multilayer body is longer than a maximum distance in the laminating direction by which the joint portion protrudes from the second principal surface of the multilayer body.

2. The multilayer ceramic capacitor according to claim 1, wherein the maximum distance in the laminating direction by which the cushion portion protrudes from the first principal surface of the multilayer body is about 5 μm or more and about 10 μm or less.

3. The multilayer ceramic capacitor according to claim 1, wherein the first plating layer and the second plating layer include at least one of a Cu plating layer, a Ni plating layer, or a Sn plating layer.

4. The multilayer ceramic capacitor according to claim 1, wherein the multilayer body has a length of about 110μm or less in the laminating direction.

5. The multilayer ceramic capacitor according to claim 1, wherein
the first outer electrode further includes a third principal surface electrode extending from a ridge portion to which the first end surface and the first principal surface are connected, to a portion of the first end surface and a portion of the first principal surface;
the second outer electrode further includes a fourth principal surface electrode extending from a ridge portion to which the second end surface and the first principal surface are connected, to a portion of the second end surface and a portion of the first principal surface;
an area of the first end surface covered by the third principal surface electrode is smaller than an area of the first end surface covered by the first principal surface electrode; and
an area of the second end surface covered by the fourth principal surface electrode is smaller than an area of the second end surface covered by the second principal surface electrode.

6. The multilayer ceramic capacitor according to claim 1, wherein the cushion portion includes a first cushion portion and a second cushion portion.

7. The multilayer ceramic capacitor according to claim 6, wherein a maximum distance in the laminating direction by which the first cushion portion protrudes from the first principal surface of the multilayer body is substantially the same as a maximum distance in the laminating direction by which the second cushion portion protrudes from the first principal surface of the multilayer body.

8. The multilayer ceramic capacitor according to claim 1, wherein the cushion portion includes metal particles that are included in at least one of the plurality of inner electrode layers.

9. The multilayer ceramic capacitor according to claim 1, wherein the joint portion includes a first joint portion and a second joint portion each including metal particles included in at least one of the plurality of internal electrodes.

10. The multilayer ceramic capacitor according to claim 9, wherein a maximum distance in the laminating direction by which the first joint portion protrudes from the second principal surface of the multilayer body is substantially the same as a maximum distance in the laminating direction by which the second joint portion protrudes from the second principal surface of the multilayer body.

11. A multilayer ceramic capacitor comprising:
a multilayer body including a plurality of dielectric layers and a plurality of inner electrode layers that are laminated, a first principal surface and a second principal surface that face each other in a laminating direction, a first side surface and a second side surface that face each other in a width direction orthogonal to the laminating direction, and a third side surface and a fourth side surface that face each other in a length direction orthogonal to the laminating direction and the width direction;
a first outer electrode coupled to one of the inner electrode layers and located on the first side surface, the third side surface, and the second principal surface;
a second outer electrode coupled to one of the inner electrode layers and located on the second side surface, the fourth side surface, and the second principal surface;
a third outer electrode coupled to one of the inner electrode layers and located on the first side surface, the fourth side surface, and the second principal surface; and
a fourth outer electrode coupled to one of the inner electrode layers and located on the second side surface, the third side surface, and the second principal surface; wherein
the second principal surface of the multilayer body is a mounting surface;
the first outer electrode includes:
a first principal surface electrode located on the first side surface, the third side surface, and the second principal surface; and
a first plating layer covering the first principal surface electrode and located on the first side surface, the third side surface, and the second principal surface;
the second outer electrode includes:
a second principal surface electrode located on the second side surface, the fourth side surface, and the second principal surface; and
a second plating layer covering the second principal surface electrode and located on the second side surface, the fourth side surface, and the second principal surface;
the third outer electrode includes:
a third principal surface electrode located on the first side surface, the fourth side surface, and the second principal surface; and
a third plating layer covering the third principal surface electrode and located on the first side surface, the fourth side surface, and the second principal surface;
the fourth outer electrode includes:
a fourth principal surface electrode located on the second side surface, the third side surface, and the second principal surface; and
a fourth plating layer covering the fourth principal surface electrode and located on the second side surface, the third side surface, and the second principal surface;
the first plating layer, the second plating layer, the third plating layer, and the fourth plating layer each include a cushion portion protruding from the first principal surface of the multilayer body and a joint portion protruding from the second principal surface of the multilayer body; and
a maximum distance in the laminating direction by which the cushion portion protrudes from the first principal surface of the multilayer body is longer than a maximum distance in the laminating direction by which the joint portion protrudes from the second principal surface of the multilayer body.

12. The multilayer ceramic capacitor according to claim 11, wherein the maximum distance in the laminating direction by which the cushion portion protrudes from the first principal surface of the multilayer body is about 5 μm or more and about 10 μm or less.

13. The multilayer ceramic capacitor according to claim 11, wherein the first plating layer and the second plating layer include at least one of a Cu plating layer, a Ni plating layer, or a Sn plating layer.

14. The multilayer ceramic capacitor according to claim 11, wherein the multilayer body has a length of about 110μm or less in the laminating direction.

15. The multilayer ceramic capacitor according to claim 11, wherein
the first outer electrode further includes a third principal surface electrode extending from a ridge portion to which the first end surface and the first principal surface are connected, to a portion of the first end surface and a portion of the first principal surface;
the second outer electrode further includes a fourth principal surface electrode extending from a ridge portion to which the second end surface and the first principal surface are connected, to a portion of the second end surface and a portion of the first principal surface;
an area of the first end surface covered by the third principal surface electrode is smaller than an area of the first end surface covered by the first principal surface electrode; and
an area of the second end surface covered by the fourth principal surface electrode is smaller than an area of the second end surface covered by the second principal surface electrode.

16. The multilayer ceramic capacitor according to claim 11, wherein the cushion portion includes a first cushion portion and a second cushion portion.

17. The multilayer ceramic capacitor according to claim 6, wherein a maximum distance in the laminating direction by which the first cushion portion protrudes from the first principal surface of the multilayer body is substantially the same as a maximum distance in the laminating direction by which the second cushion portion protrudes from the first principal surface of the multilayer body.

18. The multilayer ceramic capacitor according to claim 11, wherein the cushion portion includes metal particles that are included in at least one of the plurality of inner electrode layers.

19. The multilayer ceramic capacitor according to claim 11, wherein the joint portion includes a first joint portion and a second joint portion each including metal particles included in at least one of the plurality of internal electrodes.

20. The multilayer ceramic capacitor according to claim 19, wherein a maximum distance in the laminating direction by which the first joint portion protrudes from the second principal surface of the multilayer body is substantially the same as a maximum distance in the laminating direction by which the second joint portion protrudes from the second principal surface of the multilayer body.
